(19) United States
(12) Patent Application Publication
(10) Pub. No.: US 2013/0320097 A1
(43) Pub. Date: Dec. 5, 2013

(54) Encoded data card apparatus

(71) Applicants: William A. Anderson, II, Cumming, GA (US); Sherri D. Anderson, Cumming, GA (US)

(72) Inventors: William A. Anderson, II, Cumming, GA (US); Sherri D. Anderson, Cumming, GA (US)

(21) Appl. No.: 13/506,956

(22) Filed: May 29, 2012

(51) Int. Cl. G06K 19/06; G06K 19/00; A45C 1/00; G06K 19/077

(52) U.S. Cl. 235/492; 235/493; 235/487; 206/37

(57) ABSTRACT

An encoded data card unit apparatus includes a first unit side and an opposed second unit side coextensive with the first unit side, and also includes a case unit. A card-mounted first data-encoded magnetic stripe is mounted on the first unit side adjacent to a straight first card unit edge. A card-mounted second data-encoded magnetic stripe is mounted on the first unit side or on the second unit side adjacent to a straight second card unit edge. The first card unit edge and the second card unit edge are substantially perpendicular to each other. The first unit side and the second unit side are non-rectangular in shape. The card unit and case unit can include a number of devices or applications to protect data, and reduce fraud or identity theft.

### BACKGROUND OF THE INVENTION

1. Field of the Invention

The present invention relates generally to data-encoded cards and, more particularly, to data-encoded cards of non-rectangular shape or configuration with identity theft prevention, fraud reduction and data security countermeasure features to protect data and privacy.

2. Description of the Prior Art

Card-not-present transactions, such as mail, telephone, fax, e-commerce, and online transactions pose the greatest risk to merchants for chargebacks and to consumer for potential identify theft, data leakage, data compromises and or fraud. Such cards have particular application as credit cards, debit cards, gift cards, combined transaction card (credit card and debit card), other “value-associated” or “stored value” cards, but may also be used as identification cards, data-storage cards, telephone cards, payment cards or the like.

Credit cards, debit cards or gift cards, usually are of rectangular configuration.

Nonetheless, in my prior U.S. Design Pat. No. 405,116, issued Feb. 2, 1999, I disclose an identification card of unique circular shape.

In addition, in Nelms, et al, U.S. Pat. No. 7,290,364, there is disclosed a non-rectangular shaped credit or transaction card with an associated case.

In McGee et al, U.S. Published Patent Application No. 2005/0061889 AI, there is disclosed a non-rectangular shaped transaction card.

In Diday et al, U.S. Published Patent Application No. 2003/0132300 AI, there is disclosed a non-rectangular shaped transaction card.

In Weber et al, U.S. Published Patent Application No. 2002/0027837 AI, there is disclosed a non-rectangular shaped transaction card.

The specifications of my prior Design Pat. No. 405,116 and the Nelms, McGee, Diday and Weber et al patents are hereby incorporated herein by reference.

As pointed out by Nelms et al, special value cards have been provided by grocery, pet supply and other merchant stores in the form of cards with key loops or key chain attachment features. The advantage of having the card accessible outside of the wallet or purse, such as on a lanyard, retractable lanyard or a key chain, is that the user has the card available at his or her convenient utilization instead of having to open a purse or wallet. Having the card in the accessed position increases the likelihood of usage of the card, in contrast to requiring the user to remove the card from a wallet and/or purse and make a choice to use a particular card from among several possible choices.

Having the card already accessed and in a useable position outside of a wallet and/or purse is advantageous for the card supplier as it enhances the opportunities for use of the card. Accordingly, suppliers of conventional credit cards desire the advantages of having their particular card in the accessed position and outside of the wallet or purse. In the case of a conventional credit card, the user typically carries a number of such cards and has a choice among cards for use. For example, the user may often choose from one or more credit cards in multiple accounts or from a particular department store or other branded card. Thus, the supplier of the conventional credit card would obtain an advantage over other conventional credit cards by having the card in the accessed position, in contrast to the other cards being maintained in the wallet or purse.

Having a standard credit card in the accessed position, such as on a key chain in the same manner as a stored value card, presents additional problems. First, conventional credit cards are the target of theft of not only the card itself, but the card number printed on the card. Thus, having the credit card in the open, such as on the end of a key chain, presents a target for card thieves. Second, conventional credit cards are expected to have a longer life than a stored value card. Having the conventional credit card in the accessed position on a key chain would subject the card to substantial abuse, wear and tear, which will require more frequent replacement, or cause malfunctioning of aspects of the card, such as the magnetic stripe or cause an identification photograph to be defaced or marred.

Additionally, the size and shape of a conventional credit card makes it disadvantageous to carry for special uses such as on a lanyard, retractable lanyard or key chain attachment. The rectangular shape and conventional size requires an equally large sized container or holder to cover the card. The rectangular shape also limits the options for container size and shape and access to the card within a case. Key chain containers are inherently limited in size and weight in order to promote their use. Bulky or excessively large key chain holders will pull the key when used in a car ignition, or add weight or size to an item that is typically carried in a pocket or a purse.

Standard credit card magnetic stripe readers are designed to receive a rectangular shaped card with at least one edge that is flat or substantially straight. The cards are designed with at least one edge that is straight and parallel to the direction of the encoding on the magnetic stripe. The edge of the card serves as a reference for the stripe reading heads, which are located a specified distance from the base, or the same distance from the edge of the card to the location of the magnetic stripe.

Moreover, the magnetic stripe has a specified length and width in order to record a particular number of tracks of recorded data. These standards for card sizes, card shapes and magnetic stripe specifications provide dis-incentives for modification of the physical features of credit cards, gift cards and the associated stripe.

In addition, references mentioned above of Nelms et al, Diday et al, and Weber et al fail to contemplate the use of improved card and data security features.

### SUMMARY OF THE INVENTION

In accordance with one aspect of the invention, an encoded data card apparatus includes a card unit and a case unit which receives and houses the card unit, wherein devices in the card unit can communicate with devices in the case unit.

In accordance with another aspect of the invention, an encoded data card unit apparatus includes a first unit side and an opposed second unit side coextensive with the first unit side. A card-mounted first data-encoded stripe is mounted on the first unit side adjacent to a straight first card unit edge. A card-mounted second data-encoded stripe is mounted on the first unit side or on the second unit side adjacent to a straight second card unit edge. The first card unit edge and the second card unit edge are substantially perpendicular to each other.

The first unit side and the second unit side are non-rectangular in shape.

The card-mounted first data-encoded stripe is a card-mounted first magnetic stripe, and the second data-encoded stripe is a card-mounted second magnetic stripe. The card unit can include a self-contained pin hole camera with a wireless video transmitter. The card unit can include a partial or full digital account number line with encoded, non-encoded, encrypted or non-encrypted data relating to that account number.

The card unit can include an embedded fraud management subscriber identification detection analyzer with encoded, non-encoded, encrypted or non-encrypted data relating to a subscriber or card unit usage.

The card unit can include a logo, an image, a printed name, a printed account number, or any other information in a printed, embossed, photographed or etched format, or any combination of these features.

The card unit can include a number of additional devices and applications which include a digital card verification value display line with random generation number, a RFID chip with forensic data application, a card-mounted bar code, a physical signature stripe, a digital or electronic signature line, a credit monitoring application chip, an electronic satellite mapping and tracking chip, a card-mounted health check chip, a card-mounted antenna for wireless communication, an enterprise intelligence risk management application, a threat and vulnerability application, a digital mini audio recording chip, and a punched hole.

In accordance with another aspect of the invention, the case unit can include a case base portion which includes an interior card receptacle portion.

The case unit can include a case-mounted bar code mounted on the case base portion, a case-mounted electronic satellite tracking chip mounted on the case base portion, a case-mounted microprocessor mounted on the case base portion, and a USB port mounted on the case base portion.

The case unit can include a case-mounted slider plate mounted on the case base portion, a slider-plate-mounted magnetic stripe mounted on the case mounted slider plate, and a slide button mounted on the case-mounted slider plate for allowing a portion of the case-mounted slider plate to move outside the case unit to expose the slider-plate-mounted magnetic stripe for reading in a magnetic stripe reader.

The case unit can include a number of additional devices and applications which include a case-mounted health check chip mounted on the case base portion, a contactless sensor application, and a case-mounted antenna for wireless communication.

In addition, the case unit can be accessed in a variety of ways, such as a belt or clothing, or kept in a pocket or bag. The case unit is configured to hold, conceal or protect the non-rectangular shaped credit card unit, debit card unit or a gift card unit or other value-associated card or other-purpose card, but render the card unit easily accessible for reading on a card reader.

The case unit can also serve in the authentication, validation, analytical, fraud identification and fraud reduction process of the end user's card or transaction. In addition, identify theft, anti-fraud and data security countermeasure features can be provided in the card unit and/or the case unit to focus on strengthening card authentication, transaction monitoring, transaction research, transaction analysis, address verification, transaction velocity verification, geographical verification, fraud detection, fraud prevention, data leakage prevention, data leakage identification, fraud reduction, risk transaction modeling and; identifying and reducing potential identity theft red flags to the card user and card activities.

With one embodiment of the invention, an unconventional, non-rectangular shaped credit card unit, debit card unit, gift card unit or combination card unit (i.e. credit and debit card, gift and prepaid card) is provided with a dual magnetic stripe, and an associated case unit with authentication, validation, analytical, fraud prevention, fraud identification, fraud reduction, data life cycle features and security countermeasures, that still allow usage with a standard magnetic stripe card reader because it provides straight edge portions for maintaining the ability of most card readers to sense the stripe on the card unit. As such, the present invention incorporates the “best of all worlds for payment cards” with respect to the desirable features, card security attributes and privacy protection mentioned herewithin.

The card unit of the encoded data card apparatus of the present invention is suited to carry a bar code feature, self-contained pin hole camera with a wireless IP video transmitter, digital account line, embedded fraud management application, satellite mapping and tracking application, radio-frequency identification chip, credit monitoring application, digital card verification value application, bar code application, health check diagnostic application, electronic signature line, enterprise intelligence risk management application, threat & vulnerability management application and magnetic stripe on the slide plate in addition to a magnetic stripe to allow for greater functionality with electronic payment systems, and for greater risk mitigation tools to reduce identity theft, card fraud, transaction fraud and data leakage events to card holders and financial transactions.

The present invention relates to a credit card, debit card, gift card, pre-paid card, telephone card or any combined transaction cards (i.e. for example, credit and debit card, etc.) preferably of non-rectangle or semi non-rectangle shape, that has an associated case unit that is accessed in a variety of ways, such as on a lanyard, retractable lanyard or a key chain, clipped to an accessory such as a belt or clothing, or kept in a pocket or bag. The case unit is configured to hold a non-rectangle, rectangle or semi non-rectangle credit card unit, debit card unit or gift card unit, as well as other types of magnetic stripe or barcode cards, such as telephone cards, loyalty cards, pre-paid cards, identification cards and stored value cards.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a number of preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing others structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a top view showing a preferred embodiment of the card unit of the encoded data card apparatus of the invention.

FIG. 2 is a left edge view of the embodiment of the card unit shown in FIG. 1 taken along line 2-2 of FIG. 1.

FIG. 3 is a bottom view of the embodiment of the card unit of FIG. 2 taken along line 3-3 thereof.

FIG. 4 is a front view of an embodiment of a case unit of the invention, in a closed status, which contains an embodiment of the card unit of the invention therein.

FIG. 5 is a top view of an embodiment of the case unit of the invention of FIG. 4, taken along line 5-5 of FIG. 4, in an open status, wherein the card unit of the invention is removed from the case unit.

FIG. 6 is a front view of an embodiment of the case unit of the invention of FIG. 5, taken along line 6-6 of FIG. 5, in an open status, which contains the card unit of the invention therein.

FIG. 7 is a front view of the embodiment of the case unit of the invention of FIG. 5, taken along line 7-7 of FIG. 5, which views the bottom of card receptacle portion.

FIG. 8 is a back view of the embodiment of the case unit in FIG. 4.

### DESCRIPTION OF THE PREFERRED EMBODIMENT

With reference to the drawings, a new and improved encoded data card apparatus embodying the principles and concepts of the present invention will be described.

An encoded data card apparatus 10, as shown in FIG. 6, includes a card unit 12 and a case unit 60 which receives and houses the card unit 12, wherein devices in the card unit 12 communicate with devices in the case unit 60.

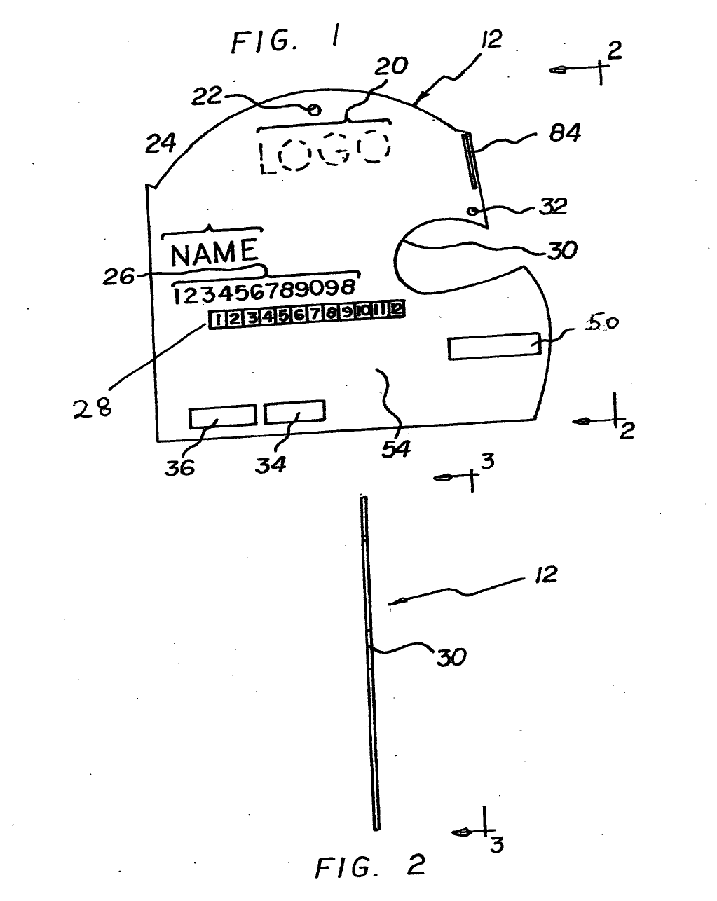

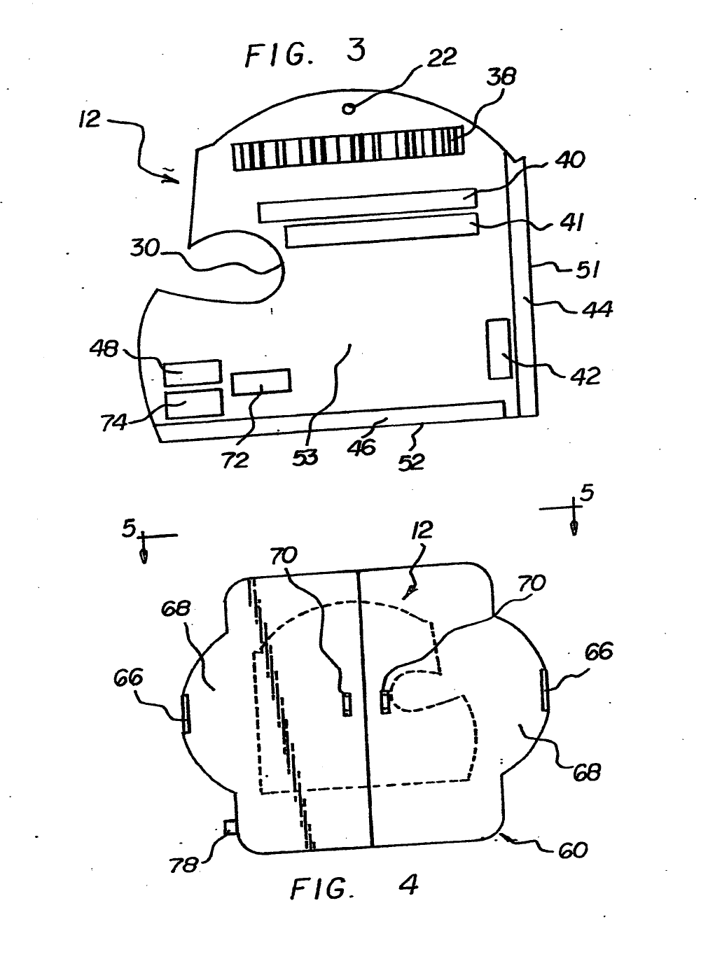

Preferably, the encoded data card unit apparatus 12, as shown in FIGS. 1-3, includes a first unit side 53 and an opposed second unit side 54 coextensive with the first unit side 53. A card-mounted first data-encoded stripe 44 is mounted on the first unit side adjacent to a straight first card unit edge 51. A card-mounted second data-encoded stripe 46 is mounted on the first unit side or on the second unit side 54 adjacent to a straight second card unit edge 52. The first card unit edge 51 and the second card unit edge 52 are substantially perpendicular to each other, whereby the card-mounted first data-encoded stripe 44 and the card-mounted second data-encoded stripe 46 are substantially perpendicular to each other.

The first unit side 53 and the second unit side 54 are non-rectangular in shape. The card-mounted first data-encoded stripe 44 is a card-mounted first magnetic stripe 44, and the second data-encoded stripe 46 is a card-mounted second magnetic stripe 46. The card-mounted first magnetic stripe 44 and the card-mounted second magnetic stripe 46 can be thought of as dual magnetic stripes, or, more generally as dual data-encoded stripes. If desired, the dual data-encoded stripes can provide encoding for a credit card and encoding for a debit card on the same card unit 12. Or, the dual data-encoded stripes can be employed for any other combination of a value-associated cards selected from the group containing credit cards, debit cards, gift cards, stored value cards, identification cards, loyalty cards, pre-paid cards, access control cards and telephone cards. The dual data-encoded stripes are adaptable to communicate with card unit 12 features and card unit 60 features, in addition to associated electronic payment systems and mechanisms through a card reader, hand scanner, bar coder reading device or any other electronic or points-of-sale payment devices or systems.

The non-rectangular configuration can be any suitable non-rectangular configuration. The non-rectangular configuration can includes a cut out curvature 30. More specifically, a die cut curvature can be present on one of the vertical sides of the card unit 12. The die cut curvature may or may not have a protective cover.

The card unit 12 can include a self-contained pin hole camera with a wireless video transmitter 32. The card unit wireless video transmitter can employ a wireless Internet Protocol (i.e. IP) video transmitter with a protective pivotal cover. This self-contained pin hole camera with a wireless video transmitter 32 feature may also serve as an investigative tool if the card unit 12 was stolen or altered. The self-contained pin hole camera with a wireless video transmitter 32 is supported by all the card security features and data security countermeasures from card unit 12 and case unit 60.

The card unit 12 may have a partial or full digital account number line 28 relating to that account number. The digital account number line 28 is supported by all the card security features and data security countermeasures from card unit 12 and case unit 60.

The card unit 12 may contain a photograph line, display or window of a hidden group of electronic digital steganography holographic photographs or images. This hidden group of photographs/images may be images of the card user or any other shapes or designs not visible to the human eye or the card user. The card reader, scanning device or point of sales system would interface with the photograph line, display or window application on card unit 12 to validate or authenticate if card unit 12 has been altered or cloned. When card unit 12 is swiped it may transmit an image of one or more of the hidden steganography images to the point of sale system. The images would appear on the point of sales display. The point of sale user could physically retrieve card unit 12 from the end user and verify the transmitted images on the point of sales system with images on card unit 12 using an ultra violet UV or any other type of security device to view these images. In practice, the transmitted images on the point of sales display monitor and the actual images on card unit 12 should match based on observation. The photograph line, display or window is supported by all the card security features and data security countermeasures from card unit 12 and case unit 60.

The card unit 12 can include an embedded fraud management subscriber identification detection analyzer. A card reader, scanning device or point of sales system would interface with the embedded fraud management subscriber identification detection analyzer 36 to obtain, report, query, collate, analyze, validate or authenticate if the card unit 12 has been stolen, altered, cloned or identify anomalies associated with the spending behaviors, geographical behaviors, velocity behaviors, address behaviors, transaction behaviors, risk behaviors or, potential data leak events or identity theft red flags to the card user or pending transaction. In conjunction with the point of sales system, the embedded fraud management subscriber identification detection analyzer application would perform a risk and fraud modeling analysis function of the transaction and card usage to identify fraudulent activity, cloned activity or anomalies to the card or card usage. If the point of sales system indicates an anomaly with the card or card usage, the point of sales system would not authenticate the card unit 12 with an approval code, and share or exchange risk information with card unit 12. The embedded fraud management subscriber identification detection analyzer stripe or chip application feature may also serve as an investigative tool if the card unit 12 was stolen, altered or cloned. This embedded fraud management subscriber identification detection analyzer would also communicate with other card unit 12 features and case unit 60 features to identify, evaluate and mitigate risk, fraud or anomalies to card unit 12 and case unit 60.

The card unit 12 can include a logo 20, an image, a printed name 24, a printed account number 26, or any other information in a printed, embossed, photographed or etched format, or any combination of these features.

The card unit 12 can include a digital card verification value display line with random generation number 50. The card reader, scanning device or point of sales system would interface with the digital card verification value display line with random generation number 50 on the card unit 12 to query, validate and authenticate if card unit 12 has been stolen, altered or cloned. If the card reader, scanning device or point of sales system indicates an anomaly with card unit 12, the point of sales system would not authenticate the card unit 12 with an approval or approval code. The point of sales system would not validate the card unit 12 as a valid card or transaction, and would share or exchange risk information with card unit 12. The digital card verification value display line would also communicate with other card unit 12 features and case unit 60 features to identify, evaluate and mitigate risk, fraud or anomalies to card unit 12 and case unit 60. The digital card verification display line is supported by all the card security features and data security countermeasures from card unit 12 and case unit 60.

The card unit 12 can include a RFID chip with a forensic data application 34. The card reader, scanning device or point of sales system would interface with the RFID chip with a forensic data application 34 on the card unit 12 to query, collate or analyze, if the card unit 12 has been stolen, altered, cloned, cloaked or identifying anomalies associated with the spending behaviors, geographical behaviors, velocity behaviors, address behaviors, transaction behaviors, risk behaviors or, potential data leak events or identity theft red flags to the card user or transaction. If the card reader or point of sales system indicates an anomaly with the card unit 12, the point of sales system would not authenticate the card unit 12 with an approval or approval code, and would share or exchange risk information with card unit 12. The RFID chip would collate and maintain a baseline forensic environment of the card unit's 12 initiated card features and all future card anomalies including session and application access/activities by the user of card unit 12 and external parties with access to card unit 12. The RFID chip would also communicate with other card unit 12 features and case unit 60 features to identify, evaluate and mitigate risk, fraud or anomalies to card unit 12 and case unit 60. This RFID chip with forensic data application 34 feature may also serve as a data forensic investigative tool, ediscovery or data life cycle feature if the card was stolen, altered, cloned, cloaked, improperly reloaded, reimaged or re-engineered to circumvent card security controls.

The card unit 12 can include a card-mounted bar code 38, bar code stripe or bar code line. The card reader, scanning device or point of sales system would interface with the card-mounted bar code 38 on the card unit 12 to validate or authenticate if the card unit 12 has been stolen, altered, improperly reloaded, reimaged or re-engineered. If the card reader, scanning device or point of sales system indicates an anomaly with card unit 12, the point of sales system would not authenticate the card unit 12. The point of sales system would share or exchange risk information with card unit 12. The card-mounted bar code is supported by all the card security features and data security countermeasures from card unit 12 and case unit 60.

The card unit 12 can include a physical signature strip for the card user to sign their name.

The card unit 12 can include a digital or electronic signature line 41. The digital or electronic signature line 41 interfaces with the physical signature line 40 to match the card user's signature or e-signature on file with the financial institution. The card reader, scanning device or point of sales system would interface with a digital or electronic signature line 41 on the card unit 12 to query, validate, authenticate if the card unit 12 has been stolen, altered, cloned, cloaked, reloaded, re-imaged, or re-engineered to circumvent card security controls. If the card reader or point of sales system indicates an anomaly with card unit 12, the point of sales system would not authenticate the card unit 12 or transaction. The point of sales system and card unit 12 would share or exchange risk information regarding the denied or non-authenticated transaction. The digital or electronic signature line may also contain a digital fingerprint of the card user, as a biometric identifier unique to the card user. The digital or electronic signature line would also communicate with other card unit 12 features and case unit 60 features to identify, evaluate and mitigate risk, fraud or anomalies to card unit 12 and case unit 60. The digital or electronic signature line is supported by all the card security features and data security countermeasures from card unit 12 and case unit 60.

The card unit 12 can include a credit monitoring application chip 42. The card reader or point of sales system would interface with the credit monitoring application chip 42 on card unit 12 to query, analyze, validate and/or authenticate if card unit 12 has been stolen, altered, re-imaged, cloned, reloaded, fraudulently used, or identifies anomalies associated with the credit behaviors, spending behaviors, geographical behaviors, velocity behaviors, address behaviors, transaction behaviors, risk behaviors, fraud behaviors, potential data leak events or identity theft red flags to the card user or pending transaction. If the card reader or point of sales system in conjunction with the credit monitoring application indicates an anomaly with the transaction, card usage, or credit history of card user, the point of sales system may not authenticate the card unit 12. The credit monitoring application chip 42 feature would also serve as a fraud investigative tool if card unit 12 was stolen, altered, re-imaged, cloaked, cloned or re-engineered. The credit monitoring application would communicate with other card unit 12 features and case unit 60 features to identify, evaluate and mitigate risk, fraud and anomalies to card unit 12 and case unit 60. The credit monitoring application is supported by the card security features and data security countermeasures from card unit 12 and case unit 60.

The card unit 12 can include an electronic satellite tracking and mapping chip 74. The card reader or point of sales system would interface with the satellite tracking and mapping application 74 on card unit 12 to query, analyze, collate, map and/or track if card unit 12 has been stolen, altered, cloned or identifies anomalies associated with the geographical behaviors, velocity behaviors address behaviors, risk behaviors, fraud behaviors, potential data leak events or identity theft red flags to the card user or the pending transaction. The point of sales system and card unit 12 would share or exchange any risk information. This satellite tracking and mapping application feature would also serve as a fraud or risk investigative tool if card unit 12 was stolen, altered cloned, cloaked, re-imaged, reloaded or re-engineered. The satellite tracking and mapping application would communicate with other card unit 12 features and case unit 60 to identify, evaluate and mitigate risk, fraud or anomalies to card unit 12 and case unit 60. The electronic satellite tracking and mapping application is supported by the card security features and data security countermeasures from card unit 12 and case unit 60.

The card unit 12 can include enterprise intelligence risk management application tools 72. The enterprise intelligence risk management application interfaces with card unit 12 features (i.e. partial or full digital account line, embedded fraud management application, satellite tracking application, RFID chip, credit monitoring application, digital card validation value application, dual magnetic stripe, bar code application, health check diagnostic application, threat & vulnerability management application, contactless interface application, electronic signature line and the magnetic stripe on the slide plate, et al.) to identify and quarantine any electronic risks, intrusions or attacks including but not limited to botnets, malicious code, trojan horses, Zeus Trojan, viruses, spyware, worms, rootkits, key logging, skimming devices, firewall attacks, encryption attacks, suspicious data execution or any other data security threats to card unit 12, including inadvertent access to encoded or non-encoded data on card unit 12. The enterprise intelligence risk management application on card unit 12 would temporarily store and quarantine the attack or attempted attack within a card layered firewall application, then launching temporary countermeasures against the electronic or data attack while directing any attack, electronic risk, intrusion or data security threats in an encrypted manner, to the threat and vulnerability management application on case unit 60 to store, analyze, manage and resolve the electronic threats to card unit 12. The enterprise intelligence risk management application on card unit 12 may also perform an electronic interface through the merchant's point of sale system to receive or report to the financial institution's acquirer processing system, card association's network and the card issuer's interchange any potential information or data security risks with card unit 12.

The enterprise intelligence risk management application on card unit 12 and case unit 60 would share any electronic intrusions or information security threats to card unit 12 with the threat and vulnerability management application on case unit 60. The enterprise intelligence risk management application on card unit 12 continuously, non-continuously or by applied card security rules, monitors or scans for electronic alterations or information security threats to card unit 12. The enterprise intelligence risk management application on card unit 12 may be a computer chip, microprocessor, internal miniature hard drive, stripe type device or combination of electronic computer chips, microprocessors or hard drive devices in any design or digital media. The enterprise intelligence risk management application stripe or chip component may be any size or design to accommodate the card unit 12 design. The enterprise intelligence risk management application supports and enhances information or data security strategies to prevent or reduce fraud, identity theft, key logging, skimming, firewall attack, encryption attack, suspicious data execution, vishing, phlishing or smishing. The enterprise intelligence risk management application on card unit 12 would communicate with other card unit 12 features and case unit 60 features to identify, evaluate and mitigate risk, fraud or anomalies to card unit 12 and case unit 60.

The card unit 12 can include a card-mounted all around surveillance suppression gyro stabilizer application chip to interface with all other card unit 12 features (i.e. partial or full digital account line, embedded fraud management application, satellite tracking application, RFID chip, credit monitoring application, digital card verification value application, dual magnetic stripe, bar code application, health check diagnostic application, contactless interface application, electronic signature line, enterprise intelligence risk management application, threat and vulnerability management application and the magnetic stripe on the slide plate, other card applications, et al) to continuously monitor, surveil, collate and/or quarantine attacks, electronic threat patch management countermeasures, re-engineering attempts to circumvent card security features and threat definitions on card unit 12 and against the card unit 12 features. The quarantined attacks, electronic threat patch management countermeasures, re-engineering attempts and threat definitions would be evaluated, collated and maintained on the all-around surveillance suppression gyro stabilizer application, within an embedded card layered firewall application, in an encrypted environment. The all-around surveillance suppression gyro stabilizer application may launch an electronic red team countermeasure analysis against these attacks or attempts inside of the encrypted card layer firewall embedded within the all-around surveillance suppression gyro stabilizer application, or also act as an early warning feature with a passive stabilizing feature, or may also reverse direct or push back the quarantined electronic or data attacks to the original source or sources with an attached encrypted or non-encrypted electronic diversion tag, as a suppression countermeasure. The electronic diversion tag may be corrupted data, non-corrupted data, value data, missing value data, disinformation data, random data, formatted data, unformatted data, encoded data, non-encoded data, numerical data, alpha data, encrypted data, non-encrypted data, image data, photographic data, special character data, executable data, non-executable data, steganography data, or a combination of any of the suppression countermeasure data sets aforementioned, or any other applied or non-applied statistical data sets. The all-around surveillance suppression gyro stabilizer application also receives updated credit card threat definitions, fraud detection data, anti-virus threat definitions, spyware definitions or any type of electronic patch management countermeasures from the financial institution's acquirer processing system, card association's network and/or card issuer's interchange regarding any potential information or data security risks with card unit 12 or card security updates. Once the updates are obtained, the data is shared with the threat and vulnerability management application on case unit 60. The all-around surveillance suppression gyro stabilizer feature maintains a second set of card unit 12 features including but not limited to the embedded fraud management application, satellite tracking application, RFID chip, credit monitoring application, health check diagnostic application, enterprise intelligence risk management application, threat and vulnerability application, as a dual redundancy and a back-up for card unit 12 features. The all-around surveillance suppression gyro stabilizer application would communicate with other card unit 12 features and case unit 60 features to identify, evaluate and mitigate risk, fraud or anomalies to card unit 12 and case unit 60.

The card unit 12 can include a card-mounted health check chip 48 to interface with other card unit 12 features (i.e. partial or full digital account line, embedded fraud management application, satellite tracking application, RFID chip, credit monitoring application, digital card verification value application, dual magnetic stripe, bar code application, health check diagnostic application, contactless interface application, electronic signature line and the magnetic stripe on the slide plate, or other card unit 12 applications), to query and identify any alterations to card unit 12 outside of its original configuration, either physical or electronic in nature to card unit 12, includes encoded or non-encoded data on card unit 12 or case unit 60. The health check diagnostic application on card unit 12 would temporarily store any alterations to card unit 12 and may interface with the health check diagnostic application on the case unit 60 to further query and identify any alternations to card unit's 12 historical footprint or configuration as part of card unit's 12 data life cycle. The health check diagnostic application on card unit 12 would also interface with the card reader or point of sales system indicating an anomaly associated with the spending behaviors, geographical behaviors, velocity behaviors, address behaviors, transaction behaviors, risk behaviors, fraud behaviors, potential data leak events or identity theft red flags to card unit 12. The health check diagnostic application on card unit 12 and case unit 60 would share or store any alterations, variances or anomalies to card unit 12 within its health check diagnostic application or with other card unit 12 features or case unit 60 features. The health check diagnostic application may be a computer chip, microprocessor or stripe type device. In practice, on activation of card unit 12, the health check diagnostic application would initiate and establish a base line diagnostic footprint of the card unit 12 features, behaviors, habits; and assigned card unit 12 spending or credit attributes/limits from the financial institution's acquirer processing system, card association's network and the card issuer's interchange. In addition, the health check diagnostic application would capture and monitor card unit 12 and case unit 60 electronic account changes including but not limited to account changes by financial institution's acquirer processing system, card association's network and the card issuer's interchange changes to card user's credit limit, authorizations, address changes, transactions and administrative sessions (i.e. programming, admin identifiers and user identifiers of financial institutions acquirer processing system, card association network, card issuer's interchange, et al). The health check diagnostic application would communicate with other card unit 12 features and case unit 60 features to identify, evaluate and mitigate risk, fraud or anomalies to card unit 12 and case unit 60.

The card unit 12 can include a card-mounted antenna for wireless communication 84. The card-mounted antenna for wireless communication 84 can be used to interface with card unit 12 applications, features or components (devices) such as the partial or full digital account line, embedded fraud management application, electronic satellite tracking application, RFID chip, credit monitoring application, digital card verification value application, dual magnetic stripe, bar code application, health check diagnostic application, electronic signature line, digital mini audio recording chip and the magnetic stripe on the slide plate, and other card unit 12 features, et al. Communications using the card-mounted antenna for wireless communication 84 can be encrypted in their entirety or as separate intrigue applications to protect data in transit, data being temporarily stored or data at rest on the card. The card mounted antenna is supported by all the card security features and data security countermeasures from card unit 12 and case unit 60.

The card-mounted antenna for wireless communication 84 can also communicate with case-mounted applications or devices such as microprocessor, universal serial bus (USB) port, electronic satellite mapping and tracking application, bar code application, health check diagnostic application, contactless interface application and the magnetic stripe on the slide plate et al, in an encrypted manner. The encryption should be consistent with the Payment Card Industry (PCI) Standards and/or best industry cryptography practices for protecting data against intrusions or data compromises.

The card unit 12 can include a passive or active digital mini audio recording chip for voice stress testing or analysis of the card user or transaction. This digital mini audio recording chip application may be a self-contained device or house a remote activation feature. The digital mini audio recording chip would also serve as an investigative tool if card unit 12 was altered, stolen, cloned, skimmed, reimaged, improperly reloaded or re-engineered to circumvent card security controls. The digital mini audio recording chip application is supported by all the card security features and data security countermeasures from card unit 12 and case unit 60.

The card unit 12 can include a punched hole 22. The punched hole 22 can accommodate a lanyard or a key chain loop. The connection of a lanyard or a key chain loop can be connected to the punched hole 22 by a generally cylindrically shaped rivet or pin. The pin can have an aperture opening therein to permit passage with a retractable lanyard and or a key chain loop. Also, the case unit 60 can also include its own punched hole that is in registration with the punched hole 22 of the card unit 12. In this way, a lanyard or key loop can be is connected to both the punched hole 22 in the card unit 12 and the complementary punched hole in the case unit 60.

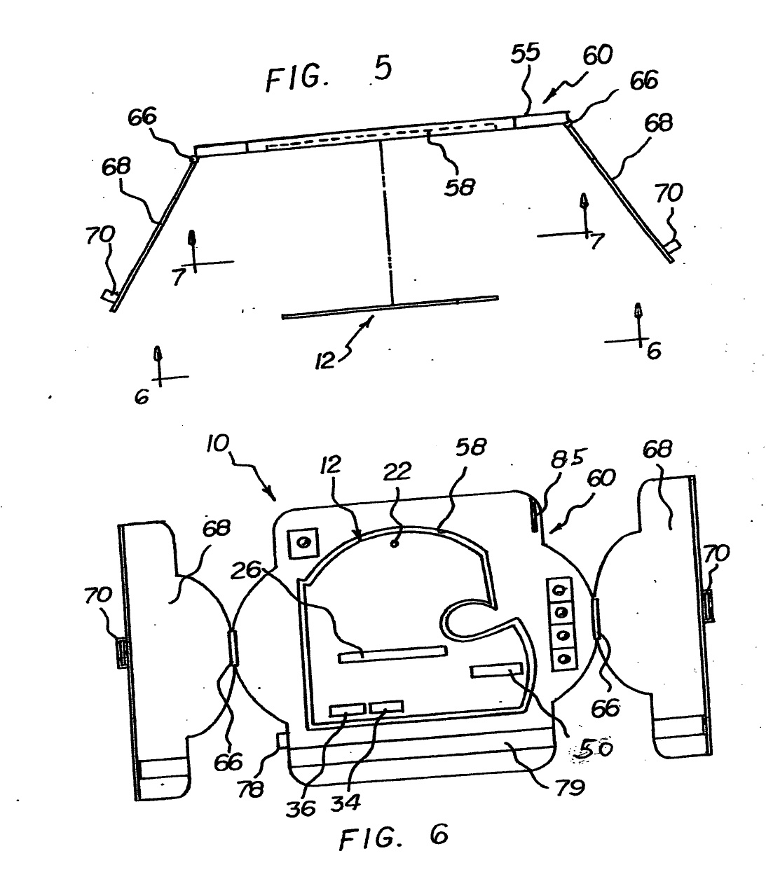

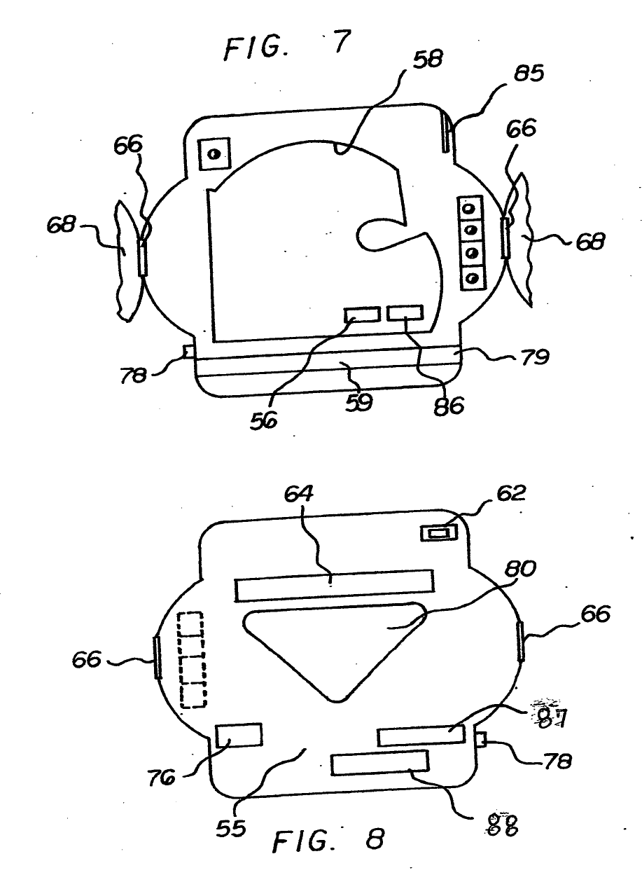

Preferably, as shown in FIGS. 4-8, a case unit 60 apparatus is provided for carrying a card unit 12 which includes a case base portion 55, and case cover doors 68 are provided for covering the case base portion 55. Case hinges 66 are interconnected between the case base portion 55 and the case cover doors 68.

The case cover doors 68 include case door clasps 70. When the case door clasps 70 are locked together, the case cover doors 68 stay locked together in a closed status. When the case door clasps 70 are not locked together, the case cover doors 68 can be opened, and the card unit 12 can be easily removed from the case unit 60. The case door clasps 70 are understood to include clasp, hinge pins, handles or any other well-known type of device to keep the case unit 60 in a close position.

The case unit 60 can include a case base portion 55 which includes an interior card receptacle portion 58. The interior card receptacle portion 58 can includes a case molding or insert to house the card unit 12. The interior card receptacle portion 58 can also be called an interior card cradle. The case molding or insert can be comprised of a plastic, paper, vinyl or any or type of material for receiving the card unit 12. The interior card receptacle portion 58 can be spring loaded, can have a hinged pin, can be riveted, glued or free standing within the case unit 60.

The card unit 60 apparatus preferably includes an interior card cradle 58. The interior card cradle may include a clear lighting source inside of said cradle to illuminate during the opening and closing of the case unit. The lighting source may be a clear light-emitting diode light (LED) or any other lighting source. The clear lighting source may be any size or design, and placed anywhere in said case unit to accommodate the case housing and case design.

The interior card cradle 58 may include several colored (i.e. red, green, yellow), lighting sources inside of said cradle to illuminate operations between the card cradle and said card. Each subsequent light would pertain to a specific operation between the card cradle and said card. For example, a green light might mean said card is mounted correctly in the card cradle. Another example, the red light might mean said card is not mounted correctly in the card cradle. The lighting source may be any colored light-emitting diode light (LED) or any other lighting source. The colored lighting sources may be any size or design, and placed anywhere in said case to accommodate the case housing and case design.

The case unit 60 can include a case-mounted bar code 64 mounted on the case base portion 55, a case-mounted electronic satellite tracking chip 56 mounted on the case base portion 55, a case-mounted microprocessor 76 mounted on the case base portion 55, and a USB port 62 mounted on the case base portion 55.

The case-mounted bar code 64, the case-mounted electronic satellite mapping and tracking chip 87, the case-mounted microprocessor 76, threat and vulnerability management application 88 and the USB port 62 can be used as interfaces and communicate with the card unit 12, while the card unit 12 is in the case unit 60 with the case cover doors 68 in the closed position. These case-mounted features are supported by all the card security features and data security countermeasures from card unit 12 and case unit 60. These case-mounted features would communicate with other case unit 60 features and card unit 12 features to identify, evaluate and mitigate risk, fraud or anomalies to case unit 60 or card unit 12.

The case unit 60 includes a case-mounted threat and vulnerability management application 88. The threat and vulnerability management application would perform an electronic interface with card unit 12 features to receive updated credit card threat definitions or fraud detection data, anti-virus threat definitions, spyware definitions or any type of electronic patch management countermeasures from the financial institution's acquirer processing system, card association's network and the card issuer's interchange regarding any potential information or data security risks to card data, card unit 12 security features or countermeasures. Once the updated credit card threat definitions or fraud detection data, anti-virus threat definitions, spyware definitions or any type of electronic threat patch management countermeasures for botnets, malicious code, trojan horses, Zeus Trojan, viruses, worms, spyware, key logging, skimming devices, firewall attacks, encryption attacks, suspicious data execution or any other information or data security threats were obtained and received by the threat and vulnerability management application on case unit 60, the threat and vulnerability management application on case unit 60 would perform a threat and vulnerability remediation on card unit 12 and case unit 60 to reduce or eliminate data security or electronic intrusion threats. The threat and vulnerability management application 88 on case unit 60 would store, quarantine, collate, analyze, manage, resolve, terminate or permanently block any illegal or suspicious electronic intrusions or data security threats to card unit 12 or case unit 60, and mitigate any electronic intrusions or data security threats to card unit 12 or case unit 60 by launching electronic threat patch management to guard, remediate and protect against data security events posed or carried out against card unit 12 or case unit 60. The threat and vulnerability management application stripe or chip component may be any size or design, and placed anywhere in or on case unit 60 to accommodate the case housing and case design. The threat and vulnerability management application would communication with other case unit 60 features and card unit 12 features to identify, evaluate and mitigate risk, fraud or anomalies to case unit 60 and card unit 12. The threat and vulnerability management application is supported by the card security features and data security countermeasures from case unit 60 and card unit 12.

In addition, the case-mounted microprocessor 76 can cause communication with the card unit 12 and an associated case-mounted electronic payment mechanism and identification of information associated with card unit 12. The case-mounted electronic payment mechanism causes transmission of information relating to information contained on card unit 12 or case unit 60.

The case unit 60 can include a case-mounted slider plate 59 mounted on the case base portion 55, a slider-plate-mounted magnetic stripe 79 mounted on the case-mounted slider plate 59, and a slide button 78 mounted on the case mounted slider plate 59 for allowing a portion of the case-mounted slider plate 59 to move outside the case unit 60 to expose the slider-plate-mounted magnetic stripe 79 for reading in a magnetic stripe reader. The case unit apparatus includes a protective outer case cover. The case cover is designed to provide excellent protection with minimal surface coverage. The protective outer cover offers direct access to all case unit 60 features—including microprocessor, slide button, bar code, USB port, contactless sensor application, electronic mapping and tracking stripe application, case clasps and all other case unit 60 applications. The protective outer cover's form-fitting material, keeps the case unit 60 protected without adding bulk. The protective outer cover may be an injection molded hard or soft composite material including but not limited to plastic, leather, paper, wood, or any other applicable material. The protective outer cover may also be an interchangeable protective cover to afford personalization of case outer cover by the end user. The protective outer cover may be water proof, water resistant, skim proof and/or skim resistant to protect the case unit 60 and card unit 12 from batter, abuse and/or data leakage.

The case unit 60 apparatus includes a built-in lithium battery or any other battery power source to support or serve as an alternative power source to said case. The battery may be any size or design, and placed anywhere in said case to accommodate the case housing and case design.

More specifically, the case-mounted slider plate 59 is usually retained inside the case unit 60. However, when it is desired to expose the slider-plate mounted magnetic stripe 79 to a magnetic strip reader (not shown), the slide button 78 is pressed, and the slider-plate-mounted magnetic stripe 79 on the case-mounted slider plate 59 is moved outside the case unit 60 to be read by a magnetic stripe reader or point of sale system to validate the card unit 12 and the case unit 60, which belong together and are in possession of the end user. The card reader or point of sales system would interface with the slider-plate mounted magnetic stripe 79 on the case unit 60 to validate or authenticate if the card unit 12 has been stolen, altered, cloned, cloaked, or identify anomalies associated with the spending behaviors, geographical behaviors, velocity behaviors, address behaviors, transaction behaviors, risk behaviors or, potential data leak events or identity theft red flags to the end user. If the card reader or point of sales system indicates an anomaly with card unit 12 and case unit 60, the point of sales system would not authenticate the card unit 12 to complete the transaction or display a processing error message to the merchant. The slider-plate mounted magnetic stripe is supported by all the card security features and data security countermeasures from card unit 12 and case unit 60.

The case unit 60 can include a case-mounted health check chip 86 mounted on the case base portion 55. The case-mounted health check chip 86 can contain a diagnostic application to interface with card unit 12 features (i.e. partial or full digital account line, embedded fraud management application, satellite tracking application, RFID chip, credit monitoring application, digital card verification value application, dual magnetic stripe, bar code application, health check diagnostic application, contactless interface application, and electronic signature line as well as the slider-plate-mounted magnetic stripe 79) to identify any alterations or variations to the card unit 12, either physical or electronic in nature with respect to the card unit 12, includes any data or data sets on card unit 12 or the case unit 60. In addition, the card-mounted health check chip 48 can interface with the case-mounted health check chip 86 to further identify any alternations or variations to the card unit 12.

The health check diagnostic application on the case unit 60 and the card unit 12 would share or store any alterations, cloning or variations to the card unit 12 within its health check diagnostic application or with other card applications or features on the card unit 12 or the case unit 60. The health check diagnostic application may be a computer chip, microprocessor or stripe type device. The health check diagnostic application on case unit 60 would communicate with other case unit 60 features and card unit 12 features to identify, evaluate and so mitigate risk, fraud or anomalies to case unit 60 and card unit 12.

The case unit 60 includes an enterprise intelligence risk management application on case unit 60 interior card cradle to interface with card unit 12 features (i.e. partial or full digital account line, embedded fraud management application, satellite tracking application, RFID chip, credit monitoring application, digital card validation value application, dual magnetic stripe, bar code application, health check diagnostic applications, enterprise intelligence risk management application on card unit 12, contactless interface application, electronic signature line and the magnetic stripe on the slide plate, et al.) to identify, collate and quarantine any electronic intrusions or electronic attacks including but not limited to botnets, malicious code, trojan horses, Zeus Trojan, viruses, worms, spyware, key logging, skimming devices, firewall attacks, encryption attacks or any other information or data security threats to card unit 12 or case unit 60, including electronic attacks or inadvertent access to any data on said card or said case. The enterprise intelligence risk management application on case unit 60 may interface with the enterprise intelligence risk management application on card unit 12 to further identify and quarantine any data security threats to said card unit 12 or case unit 60. The enterprise intelligence risk management application on case unit 60 and the enterprise intelligence risk management application on card unit 12 would share any electronic intrusions or data security threats to card unit 12 or case unit 60 with the threat and vulnerability management application, on case unit 60. The enterprise intelligence risk management application on case unit 60 would also perform an electronic interface through the merchant's point of sale system to receive or report to the financial institution's acquirer processing system, card association's network and the card issuer's interchange any potential information or data security risks with card unit 12, if the magnetic stripe on the slide plate was swiped. The enterprise intelligence risk management application on case unit 60 would direct any data threat information to the threat and vulnerability management application on case unit 60. The enterprise intelligence risk management application may be a computer chip, microprocessor, internal miniature hard drive, stripe type device or combination of electronic computer chips, microprocessors or miniature hard drive devices in any design or digital media. The enterprise intelligence risk management application stripe or chip component on case unit 60 may be any size or design to accommodate the case design. The enterprise intelligence risk management application supports and enhances information or data security strategies to prevent or reduce fraud, cloned activities or identity theft. The enterprise intelligence risk management application on case unit 60 would communicate with other case unit 60 features and card unit 12 features to identify, evaluate and mitigate risk, fraud or anomalies to case unit 60 and card unit 12.

The case unit 60 can include a contactless sensor application 80. The contactless sensor application 80 which communicates with contactless card readers and contactless point of sales systems at retail or financial institutions.

In essence, the user of the card unit 12 would place the card unit 12 in the covered position in the case unit 60, and pass the case unit 60 in front of a contactless reader to facilitate a transaction with a point of sales system without removing card unit 12 from a covered position inside the case unit 60. The contactless sensor application would be supported by all the card security features and data security countermeasures from card unit 12 and case unit 60.

Data Encryption can be used with the aforementioned components or features of the card unit 12 and the case unit 60 of the invention. More specifically, encryption can be used with a partial or full digital account line, embedded fraud management application, electronic satellite tracking application, RFID chip, credit monitoring application, digital card verification value application, dual magnetic stripe, bar code application, health check diagnostic application, electronic signature line and the magnetic stripe on the slide plate, et al. The aforementioned components or features of the card unit 12 and the case unit 60 can be encrypted in their entirety or as separate intrigue applications to protect data in transit, data being temporarily stored, or data at rest on the card unit 12 or the case unit 60. The encryption should be consistent with the Payment Card Industry (PCI) Standards and/or best industry cryptography practices for protecting data against intrusions or data compromises.

Card Layered Firewalls can be used with the aforementioned components of the card unit 12 and the case unit 60 of the invention. More specifically, firewalls can be used with card unit 12 features and/or case unit 60 features, including but not limited to the embedded fraud management application, electronic satellite mapping and tracking application, health check diagnostic application, enterprise intelligence risk management application, threat and vulnerability management application, all around surveillance suppression gyro stabilizer application chip, et al. The aforementioned components or features of card unit 12 and/or case unit 60 can be firewalled within their entire applications, embedded applications, or as separate intrigue applications (i.e. stand-alone), or in any combinations, singular or jointly, on card unit 12 and or case unit 60, to protect data on card unit 12 and case unit 60. The card layered firewall application should be consistent with the firewall rules and firewall change management standards or best industry firewall practices for identifying, protecting, managing, configuring, segmenting and enhancing data protection management on card unit 12 and the case unit 60.

The case unit 60 can include a case-mounted antenna for wireless communication 85. The case-mounted antenna for wireless communication 85 can communicate with case-mounted applications or devices such as microprocessor, universal serial bus (USB) port, electronic satellite tracking application, bar code application, health check diagnostic application, contactless interface application and the magnetic stripe on the slide plate et al. The case-mounted antenna is supported by all the card security features and data security countermeasures from case unit 60 and card unit 12.

The case-mounted applications and devices can be encrypted in their entirety or as separate intrigue applications to protect data in transit, data being temporarily stored or data at rest on the case unit 60.

The case-mounted antenna for wireless communication 85 can also communicate with the card unit 12 features or components mentioned above.

The components of the encoded data card apparatus of the invention can be made from inexpensive and durable metal, plastic or paper materials.

As to the manner of usage and operation of the instant invention, the same is apparent from the above disclosure, and accordingly, no further discussion relative to the manner of usage and operation need be provided.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. An encoded data card unit apparatus, comprising:
a first unit side and an opposed second unit side coextensive with said first unit side,
a card-mounted first data-encoded stripe mounted on said first unit side adjacent to a straight first card unit edge, and
a card-mounted second data-encoded stripe mounted on said first unit side or on said second unit side adjacent to a straight second card unit edge.

2. The card unit apparatus of claim 1 wherein said first card unit edge and said second card unit edge are substantially perpendicular to each other.

3. The card unit apparatus of claim 1 wherein: said first unit side and said second unit side are non-rectangular in shape, said card-mounted first data-encoded stripe is a card-mounted first magnetic stripe, and said second data-encoded stripe is a card-mounted second magnetic stripe.

4. The card unit apparatus of claim 1, further including:
a self-contained pin hole camera with a wireless video transmitter and a digital mini audio recording chip or application feature.

5. The card unit apparatus of claim 1, further including: digital account number line with encoded data relating to that account number.

6. The card unit apparatus of claim 1, further including: card-mounted embedded fraud management subscriber identification detection analyzer chip or application feature.

7. The card unit apparatus of claim 1 which includes a logo, an image, a printed name, a printed account number, or any other information in a printed. embossed, photographed or etched format, or any combination of these features.

8. The card unit apparatus of claim 1, further including:
a digital card verification value display line with random number generation feature.

9. The card unit apparatus of claim 1, further including: a card-mounted RFID chip with forensic data application feature.

10. The card unit apparatus of claim 1, further including: a card-mounted bar code, physical signature stripe, and a digital or electronic signature line, with or without a digital fingerprint feature.

11. The card unit apparatus of claim 1, further including: a card-mounted credit monitoring chip or application feature and a card-mounted electronic satellite mapping and tracking feature.

12. The card unit apparatus of claim 1, further including: a card-mounted health check diagnostic chip or application feature, and a card-mounted antenna for wireless communication.

13. The card unit apparatus of claim 1, further including: a photograph line, display or window of a hidden group of steganography digital holographic photographs or images.

14. A case unit apparatus for carrying a card unit, comprising: a case base portion, case cover doors for covering case unit base portion, and a protective case cover.

15. The case unit apparatus of claim 14 wherein case unit base portion includes an interior card receptacle portion.

16. The case unit apparatus of claim 14, further
including:
a case-mounted bar code mounted on case unit base portion,
a case-mounted electronic satellite mapping and tracking chip mounted on case unit base portion, a case-mounted microprocessor mounted on case unit base portion, and
an USB port mounted on case unit base portion.

17. The case unit apparatus of claim 14, further
including:
a case-mounted slider plate mounted on case unit base portion,
a slider-plate-mounted magnetic stripe mounted on case unit, mounted slider plate, and
a slide button mounted on case-mounted slider plate for allowing a portion of case-mounted slider plate to move outside case unit to expose said slider-plate-mounted magnetic stripe for reading in a magnetic stripe reader or point of sales system.

18. An encoded data
card apparatus, comprising: a case unit,
and
a card unit received in said case unit,
wherein devices in said card unit communicate
with devices and features in said case unit.

19. The card unit apparatus of claim 1, further including: a card-mounted enterprise intelligence risk management application chip or stripe application feature and a card-mounted all-around surveillance suppression gyro stabilizer application chip or application feature.

20. The case unit apparatus of claim 14, further including: an enterprise intelligence risk management application chip on said interior card receptacle portion.

21. The case unit apparatus of claim 14, further including: a case-mounted threat and vulnerability management chip or application feature, and a case-mounted antenna for wireless communication.
